(19) United States
(12) Patent Application Publication
(10) Pub. No.: US 2026/0321866 A1
(43) Pub. Date: Oct. 15, 2026

(54) RECHARGEABLE BATTERY

(71) Applicant: SAMSUNG SDI CO., LTD., Yongin-si (KR)

(72) Inventors: Seoyeon SHIN, Yongin-si (KR); Seonung CHOI, Yongin-si (KR)

(21) Appl. No.: 19/413,307

(22) Filed: Dec. 9, 2025

(30) Foreign Application Priority Data
Apr. 10, 2025 (KR) 10-2025-0047061

(51) Int. Cl. H01M 50/333; H01M 50/15; H01M 50/176; H01M 50/342; H01M 50/531

(52) U.S. Cl. CPC H01M 50/333; H01M 50/15; H01M 50/176; H01M 50/3425; H01M 50/531; H01M 2200/20

(57) ABSTRACT

A rechargeable battery, including an electrode assembly including a first electrode and a second electrode, a case housing the electrode assembly, a cap plate coupled to an opening of the case, the cap plate having a terminal hole and a vent hole configured to discharge gas, an electrode terminal installed in the cap plate, the electrode terminal including a first electrode terminal and a second electrode terminal, a lead tab including a first current collecting tab connecting the electrode assembly to the first electrode terminal and a second current collecting tab connecting the electrode assembly to the second electrode terminal, and an opening and closing unit configured to open or close in response to the pressure of the gas is in the vent hole.

### CROSS-REFERENCE TO RELATED APPLICATION

This application claims priority to and the benefit of Korean Patent Application No. 10-2025-0047061 filed with the Korean Intellectual Property Office on Apr. 10, 2025, the entire contents of which are incorporated herein by reference.

### BACKGROUND

### 1. Field

The present disclosure relates to a rechargeable battery.

### 2. Description of the Related Art

In general, a rechargeable battery is a battery that can be charged and discharged, unlike a primary battery that cannot be recharged. Low-capacity rechargeable batteries are used in small, portable electronic devices such as a cell phone, a laptop computer, and a camcorder, while large-capacity batteries are widely used as power sources for driving motors in hybrid cars.

Typical rechargeable batteries include nickel-cadmium (Ni-Cd) batteries, nickel-metal hydride (Ni-MH) batteries, lithium (Li) batteries, and lithium-ion (Li-ion) rechargeable batteries. More particularly, lithium-ion rechargeable batteries have an operating voltage that is about three times higher than nickel-cadmium batteries or nickel-metal hydride batteries, which are widely used as power sources for portable electronic devices. Additionally, it is widely used because of its high energy density per unit weight.

Rechargeable batteries mainly use lithium oxide as the positive electrode active material and a carbon material as the negative electrode active material. In general, batteries are classified into liquid electrolyte batteries and polymer electrolyte batteries depending on the type of electrolyte, and a battery that uses a liquid electrolyte is called a lithium-ion battery, and a battery that uses a polymer electrolyte is called a lithium polymer battery.

### SUMMARY

Embodiments include a rechargeable battery, including an electrode assembly including a first electrode and a second electrode, a case housing the electrode assembly, a cap plate coupled to an opening of the case, the cap plate having a terminal hole and a vent hole configured to discharge gas, an electrode terminal installed in the cap plate, the electrode terminal including a first electrode terminal and a second electrode terminal, a lead tab including a first current collecting tab connecting the electrode assembly to the first electrode terminal and a second current collecting tab connecting the electrode assembly to the second electrode terminal, and an opening and closing unit configured to open or close in response to the pressure of the gas is in the vent hole.

The opening and closing unit may include a vent plate installed at an opening position on one side of the vent hole, the vent plate having an exhaust hole through which gas is emitted, an elevation member installed at an opening position on another side of the vent hole to close the vent hole, the elevation member moving into the vent hole in response to the pressure of the gas to open the vent hole, and an elastic member between the vent plate and the elevation member.

The exhaust hole of the vent plate may include a plurality of exhaust holes.

The plurality of exhaust holes may be in a round-shaped array on the vent plate.

The plurality of exhaust holes may be in a radial arrangement centered on the through hole of the vent plate.

The plurality of exhaust holes may be connected to each other.

The plurality of exhaust holes may be connected to each other by a notch groove on a surface of the vent plate.

The notch groove may connect the plurality of exhaust holes in a round shape on the surface of the vent plate.

The notch groove may connect the plurality of exhaust holes in a polygonal shape on the surface of the vent plate.

A width of the notch groove may be smaller than a diameter of the exhaust hole.

The notch groove may be ruptured when gas is discharged at a pressure exceeding a predetermined level.

The vent hole may have a cone shape in which a first opening having a first diameter is on an upper surface of the cap plate, and a second opening having a second diameter is on a lower surface of the cap plate.

The second diameter of the second opening may be smaller than the first diameter of the first opening.

The elevation member may include an insertion portion that protrudes, the insertion portion being in the second opening of the vent hole in a non-operating state.

The elevation member may include an elevation body having an inclined surface contacting an inner wall surface of the vent hole, and the insertion portion protruding from a lower part of the elevation body to be inserted into the second opening.

The insertion portion may protrude in a cylindrical shape from the lower part of the elevation member.

The vent plate may have a circular plate shape making surface contact with an inner wall surface of the first opening.

The elastic member may be a coil spring between the vent plate and the elevation member.

A first groove may be on an inner surface of the vent plate to receive one side of the coil spring.

A second groove may be on an outer surface of the elevation member to receive another side of the coil spring.

### BRIEF DESCRIPTION OF THE DRAWINGS

Features will become apparent to those of ordinary skill in the art by describing in detail exemplary embodiments with reference to the attached drawings, in which:

FIG. 1 is a schematic perspective view of a rechargeable battery according to a first embodiment of the present disclosure;

FIG. 2 is a cross-sectional view taken along line A-A of FIG. 1;

FIG. 3 is a schematic plan view of a main body illustrating the state in which the opening and closing unit according to a first embodiment of the present disclosure is installed;

FIG. 4 is a schematic cross-sectional view of a main body illustrating the state in which the opening and closing unit according to a first embodiment of the present disclosure is installed;

FIG. 5 is a schematic cross-sectional view of a main body illustrating the state in which the elevation member of the opening and closing unit in FIG. 4 is elevated by gas pressure, thereby opening the vent hole;

FIG. 6 is a schematic perspective view of a rechargeable battery according to a second embodiment of the present disclosure;

FIG. 7 is a schematic plan view of a main body illustrating the state in which the opening and closing unit according to a second embodiment of the present disclosure is installed;

FIG. 8 is a schematic cross-sectional view of a main body illustrating the state in which the opening and closing unit of FIG. 7 is installed; and

FIG. 9 is a schematic cross-sectional view of a main body illustrating the state in which the opening and closing unit according to a third embodiment of the present disclosure is installed.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The present disclosure may be implemented in several different forms and is not limited to the embodiments described herein. In order to clearly explain the present disclosure, parts that do not have a relationship with the explanation are omitted, and identical or similar component is assigned the same reference numerals throughout the specification.

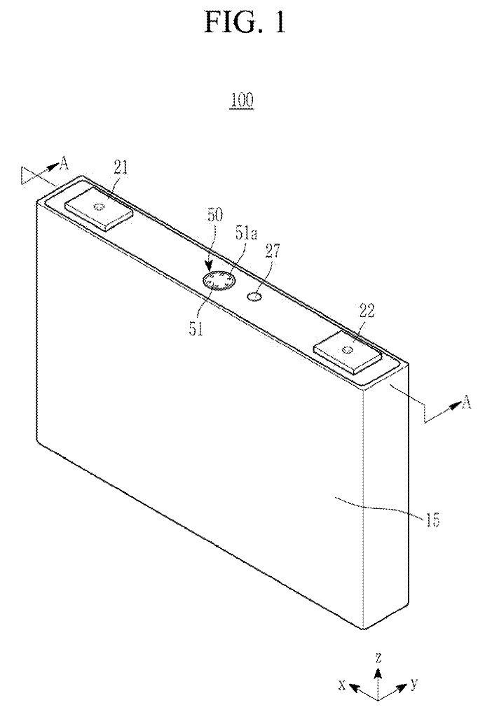

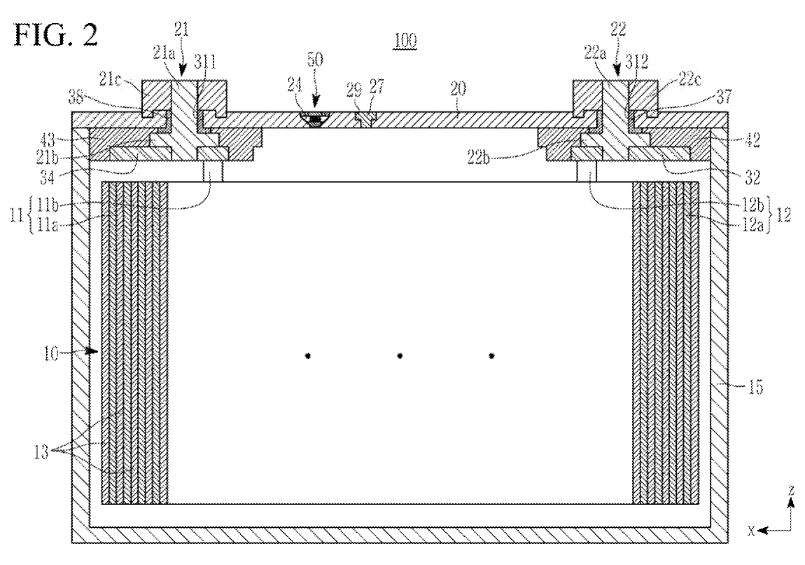

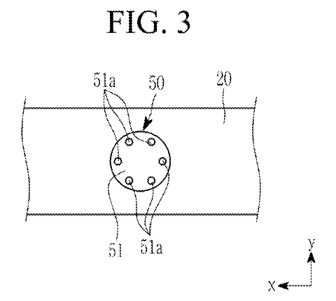

FIG. 1 is a schematic perspective view of a rechargeable battery according to a first embodiment of the present disclosure, FIG. 2 is a cross-sectional view taken along line A-A of FIGS. 1 and 3 is a schematic plan view of a main body illustrating the state in which the opening and closing unit according to a first embodiment of the present disclosure is installed.

As shown in FIGS. 1 to 3, a rechargeable battery 100 according to a first embodiment of the present disclosure includes an electrode assembly 10 having a first electrode 11 and a second electrode 12, a case 15 housing the electrode assembly, a cap plate 20 coupled to an opening of the case 15 and formed with terminal holes 311 and 312 and a vent hole 24 through which gas is discharged, electrode terminals 21 and 22 installed on the cap plate 20 and including a first electrode terminal 21 and a second electrode terminal 22, and lead tabs 32 and 34 including a first current collecting tab 34 connecting the electrode assembly 10 to the first electrode terminal 21 and a second current collecting tab 32 connecting the electrode assembly 10 to the second electrode terminal 22. Here, an opening and closing unit 50 that (e.g., is configured to) opens/closes depending on the pressure of the gas may be installed in the vent hole 24.

The electrode assembly 10 for charging and discharging current is formed by arranging a first electrode (hereinafter, referred to as a positive electrode) 11 and a second electrode (hereinafter, referred to as a negative electrode) 12 on both sides of a separator 13 which is an insulator, and winding an positive electrode 11, a separator 13, and a negative electrode 12 in a jelly roll state. In addition, hereinafter, a first electrode terminal 21 refers to a positive electrode terminal, and a second electrode terminal 22 refers to a negative electrode terminal.

Each of the positive electrode 11 and the negative electrode 12 may include coating parts 11a and 12a in which active material is coated on a current collector of a metal plate, and uncoated parts 11b and 12b formed of a current collector exposed by not coating an active material.

In this case, the uncoated part 11b of the positive electrode 11 and the uncoated part 12b of the negative electrode 12 may protrude upward from the electrode assembly 10, respectively.

The case 15 has a substantially rectangular parallelepiped shape to set a space for accommodating the electrode assembly 10 and the electrolyte therein, and an opening connecting the outside and the inner space may be formed on one surface of the rectangular parallelepiped.

The opening may allow the electrode assembly 10 to be inserted into the case 15.

The cap plate 20 is formed of a thin steel plate and is installed in the opening of the case 15, thereby sealing the case 15.

An electrolyte injection hole 29 and a vent hole 24 are formed in the cap plate 20.

The electrolyte injection hole 29 may enable an electrolyte to be injected into the case 15 after the cap plate 20 is coupled to the case 15. After the electrolyte is injected, the electrolyte injection hole 29 may be sealed with a sealing cap 27.

The negative electrode terminal 22 may be installed through the cap plate 20 and may be electrically connected to the electrode assembly 10. That is, the negative electrode terminal 22 is electrically connected to the negative electrode 12 of the electrode assembly 10, such that current of the electrode assembly 10 may be drawn out (e.g., or into if charging) of the case 15 through the negative electrode terminal 22.

The negative electrode terminal 22 may include a first rivet terminal 22a installed in the terminal hole 312 of the cap plate 20, a first flange 22b integrally formed with the first rivet terminal 22a inside the cap plate 20, and a first plate terminal 22c disposed outside the cap plate 20 and connected to the first rivet terminal 22a by riveting or welding.

A negative electrode gasket 37 may be installed between the first rivet terminal 22a of the negative electrode terminal 22 and the inner surface of the terminal hole 312 of the cap plate 20, so as to seal between the first rivet terminal 22a of the negative electrode terminal 22 and the cap plate 20.

The negative electrode gasket 37 is installed to further extend between the first flange 22b and the inner surface of the cap plate 20 to further seal between the first flange 22b and the cap plate 20.

That is, the negative electrode gasket 37 may prevent the electrolyte from leaking through the terminal hole 312 by installing the negative electrode terminal 22 in the cap plate.

Meanwhile, a negative electrode current collecting tab 32 may electrically connect the negative electrode terminal 22 to a negative electrode uncoated part 12b of the electrode assembly 10.

That is, by coupling the negative electrode current collecting tab 32 to the lower end of the first rivet terminal 22a and caulking the lower end, the negative electrode current collecting tab 32 may be connected to the lower end of the first rivet terminal 22a while being supported by the first flange 22b.

A negative electrode insulating member 42 may be installed between the negative electrode current collecting tab 32 and the cap plate 20, respectively, to electrically insulate the negative electrode current collecting tab 32 and the cap plate 20.

Also, the negative electrode insulating member 42 may be coupled to the cap plate 20 on one side and installed between the negative electrode current collecting tab 32 on the other side to stabilize the connection structure.

One side of the positive electrode terminal 21 may protrude through the terminal hole 311 of the cap plate 20, and the other side may be connected to the positive electrode current collecting tab 34 at a portion between the cap plate 20 and the electrode assembly 10.

The positive electrode terminal 21 may include a second rivet terminal 21a installed in the terminal hole 311 of the cap plate 20, a second flange 21b integrally formed with the second rivet terminal 21a inside the cap plate 20, and a second plate terminal 21c disposed outside the cap plate 20 and connected to the second rivet terminal 21a by riveting or welding.

The positive electrode gasket 38 may be installed between the second rivet terminal 21a of the positive electrode terminal 21 and the inner surface of the terminal hole 311 of the cap plate 20, so as to seal between the second rivet terminal 21a of the positive electrode terminal 21 and the cap plate 20.

The positive electrode gasket 38 may further extend between the second flange 21b and the inner surface of the cap plate 20 to further seal between the second flange 21b and the cap plate 20.

That is, the positive electrode gasket 38 may prevent the electrolyte from leaking through the terminal hole 311 by installing the positive electrode terminal 21 in the cap plate 20.

Meanwhile, the positive electrode current collecting tab 34 may electrically connect the positive electrode terminal 21 to the positive electrode uncoated part 11b of the electrode assembly 10.

That is, by coupling the positive electrode current collecting tab 34 to the lower end of the second rivet terminal 21a and caulking the lower end, the positive electrode current collecting tab 34 may be connected to the lower end of the second rivet terminal 21a while being supported by the second flange 21b.

The positive electrode insulating member 43 may be installed between the positive electrode current collecting tab 34 and the cap plate 20, respectively, to electrically insulate the positive electrode current collecting tab 34 and the cap plate 20.

Also, the positive electrode insulating member 43 may be coupled to the cap plate 20 on one side and installed between the positive electrode current collecting tab 32 on the other side (e.g., another side) to stabilize the connection structure.

Meanwhile, one side of the positive electrode terminal 21 may protrude through the terminal hole 311 of the cap plate 20, and the other side (e.g., another side) may be connected to the positive electrode current collecting tab 34 at a portion between the cap plate 20 and the electrode assembly 10.

The vent hole 24 may be sealed by an opening and closing unit 50 to discharge internal pressure of the rechargeable battery.

The opening and closing unit 50 may be operated when the internal pressure of the rechargeable battery reaches a set (e.g., predetermined) pressure to open the vent hole 24.

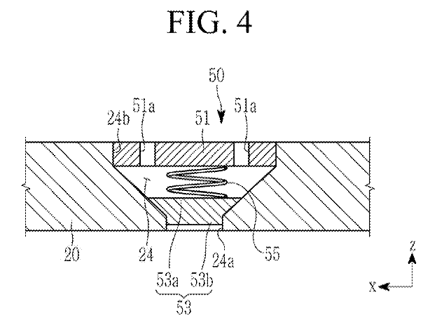

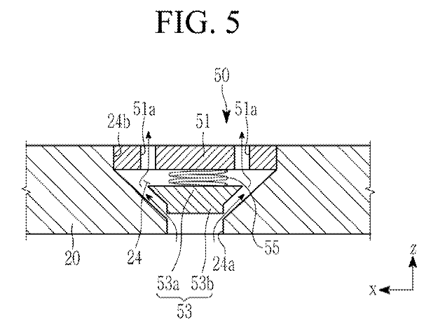

FIG. 4 is a schematic cross-sectional view of a main body illustrating the state in which the opening and closing unit according to a first embodiment of the present disclosure is installed, and FIG. 5 is a schematic cross-sectional view of a main body illustrating the state in which the elevation member of the opening and closing unit in FIG. 4 is elevated by gas pressure, thereby opening the vent hole.

More specifically, referring to FIGS. 4 and 5, the opening and closing unit 50 may include a vent plate 51 in which a gas exhaust hole 51a is formed in an opening position on one side of the vent hole 24, an elevation member 53 in which the vent hole 24 is installed in an opening position on the other side of the vent hole 24 to close the vent hole 24 and open the vent hole 24 by moving into the vent hole 24 according to the pressure of the gas, and an elastic member 55 installed between the vent plate 51 and the elevation member 53.

The vent hole 24 may be conically formed in the inner direction of the rechargeable battery in the cap plate 20.

The vent hole 24 may be formed through the cap plate 20 in the width direction so that the first opening 24b/second opening 24a are formed on both sides of the cap plate 20 in the width direction, respectively.

The vent plate 51 may be installed at the position of the first opening 24b having a first diameter on one side of the vent hole 24.

The vent plate 51 may be installed in a circular plate shape while being inserted into the position of the first opening 24b.

An exhaust hole 51a for emitting gas generated in the rechargeable battery 100 may be formed in the vent plate 51.

A plurality of exhaust holes 51a may be formed in the vent plate 51 for smooth discharge of gas. The plurality of exhaust holes 51a may be formed in a radial manner around the through hole 24 of the vent plate 51.

A plurality of exhaust holes 51a may be formed in a round arrangement along the edge of the vent plate 51 (see FIG. 3). The exhaust hole 51a is not necessarily limited to a round-shaped array but may be changed to a predetermined arrangement for easy emission of gas.

Meanwhile, an elevation member 53 may be installed under the vent plate 51 inside the vent hole 24.

The elevation member 53 may be moved to open the vent hole 24 in response to the pressure of the gas while keeping the second opening 24a of the vent hole 24 sealed.

More specifically, the elevation member 53 may include an elevation body 53a having an inclined surface formed on the side thereof to contact the inner wall surface of the vent hole 24, and an insertion portion 53b that protrudes from the lower portion of the elevation body 53a and is inserted into the second opening 24a.

The elevation body 53a may be formed in a cylindrical shape capable of elevating inside the vent hole 24. An insertion portion 53b may protrude from a lower portion of the elevation body 53a.

The insertion portion 53b may protrude in a cylindrical shape from a lower part of the elevation body 53a and may be inserted into a second opening 24a of the vent hole 24 to seal the vent hole 24.

Therefore, the insertion portion 53b of the elevation member 53 may be inserted into the second opening 24a in the initial state in which gas is not discharged so that the vent hole 24 may be sealed.

In addition, when the gas is discharged, the elevation member 53 is moved to the upper part of the vent hole 24 by the pressure of the gas, and the insertion portion 53b is separated from the second opening 24a of the second diameter, so that the vent hole 24 may be opened to facilitate gas discharge.

Here, the second diameter of the second opening 24a may be smaller than the first diameter of the first opening 24b.

Meanwhile, an elastic member 55 may be installed between the elevation body 53a and the vent plate 51. Hereinafter, the elastic member and the coil spring use the same reference number. Hereinafter, detailed descriptions of the same reference numbers will be omitted.

The coil spring 55 is installed with one side in contact with the upper part of the elevation member 53 and the other side in contact with the vent plate 51, so that when gas pressure is not applied, it can provide elasticity so that the elevation member 53 can stably seal the second opening 24a.

It is possible to set a pressure at which the gas discharged from the inside of the rechargeable battery 100 is discharged according to the stiffness of the coil spring 55. That is, when the pressure for discharging gas to the outside of the rechargeable battery is to be changed, it may be changed to a coil spring 55 having corresponding stiffness.

As described above, in the rechargeable battery 100 of this embodiment, when an abnormal gas pressure is generated, the elevation member 53 of the opening and closing unit 50 is elevated to open the vent hole 24, and thus gas can be safely emitted, and stability may be improved.

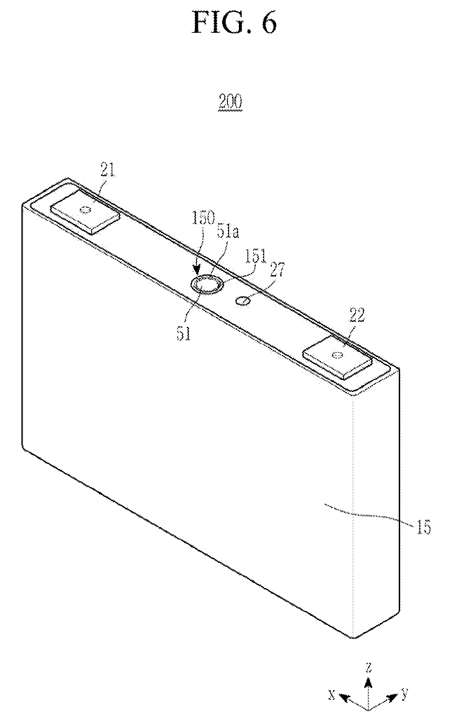

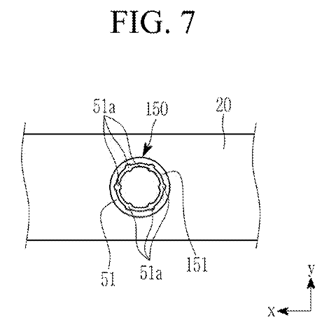

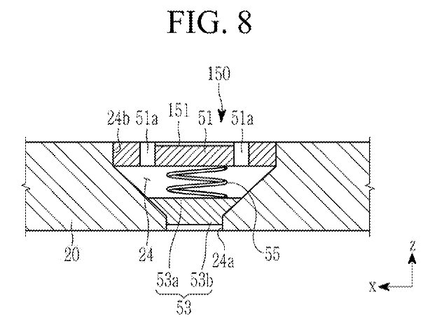

FIG. 6 is a schematic perspective view of a rechargeable battery according to a second embodiment of the present disclosure, FIG. 7 is a schematic plan view of a main body illustrating the state in which the opening and closing unit according to a second embodiment of the present disclosure is installed, and FIG. 8 is a schematic cross-sectional view of a main body illustrating the state in which the opening and closing unit of FIG. 7 is installed. The same reference numerals as in FIGS. 1 to 5 refer to the same or similar members of the same or similar function. Hereinafter, detailed descriptions of the same reference numbers will be omitted.

As shown in FIGS. 6 to 8, a plurality of exhaust holes 51a formed in the vent plate 51 of the opening and closing unit 150 of the rechargeable battery 200 according to the second embodiment of the present disclosure may be connected to each other by a notch groove 151 formed on the surface of the vent plate 51.

The notch groove 151 may connect a plurality of exhaust holes 51a in a round shape. The notch groove 151 is not limited to connecting the exhaust holes 51a in a round shape and may also be connected, for example, in a polygonal shape.

The notch groove 151 is formed on the surface of the vent plate 51 and connects a plurality of exhaust holes 51a to each other and may be ruptured if gas exceeding the set pressure (e.g., predetermined pressure) is generated inside the rechargeable battery 200.

That is, when gas of a predetermined pressure is generated inside the rechargeable battery 100, the gas is not discharged smoothly through the exhaust hole 51a alone. Accordingly, when gas exceeding the predetermined pressure is generated inside the rechargeable battery 100, a plurality of the notch groove 151 are broken to form holes with a diameter larger than the exhaust hole 51a, so that the gas may be discharged smoothly.

The width of the notch groove 151 is formed smaller than the diameter of the exhaust hole 51a, so that the breaking action occurs smoothly when the gas is discharged, and thus the gas with abnormal pressure generated inside the rechargeable battery 100 can be smoothly discharged.

In this way, smooth discharge of gas under abnormal pressure generated inside the rechargeable battery 200 is possible, thereby preventing an explosion due to gas pressure.

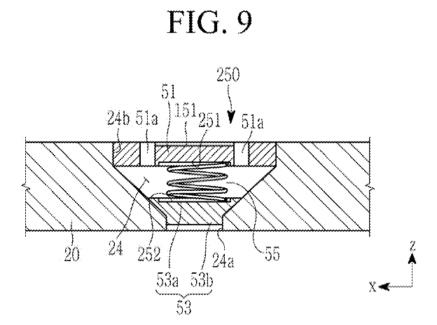

FIG. 9 is a schematic cross-sectional view of a main body illustrating the state in which the opening and closing unit according to a third embodiment of the present disclosure is installed. The same reference numerals as in FIGS. 1 to 8 refer to the same or similar members of the same or similar function. Hereinafter, detailed descriptions of the same reference numbers will be omitted.

As shown in FIG. 9, the first groove 251 into which one side of a coil spring 55 is inserted may be formed in an inner surface of the vent plate 51 of the opening and closing unit 250 of the rechargeable battery according to the third embodiment of the present disclosure.

In addition, a second groove 252 into which the other side of the coil spring 55 is inserted may be formed in an outer surface of the elevation member 53.

Therefore, the coil spring 55 is installed in a state in which both sides are inserted into the first groove 251 and the second groove 252, respectively, between the vent plate 51 and the elevation member 53, so that the coil spring 55 may be stably installed to provide an appropriate elastic force for the elevation operation of the elevation member.

Rechargeable batteries have a problem in that if excessive gas under abnormal pressure is generated, the gas is not discharged smoothly, causing an explosion or other problems, thereby reducing stability.

According to an embodiment of the present disclosure, since the opening and closing unit is increased in the vent hole by the pressure of the gas and is raised to open the vent hole, the gas may be safely emitted and stability may be improved.

According to one embodiment of the present disclosure, a plurality of exhaust holes through which gas is discharged and a notch groove connecting the plurality of exhaust holes are formed in an opening and closing unit, so that when gas exceeding a set pressure is generated, the notch groove is ruptured to enable smooth discharge of the gas, thereby preventing an explosion due to abnormal pressure and enabling safe discharge of the gas.

Although the preferred embodiments of the present disclosure have been described above, the present disclosure is not limited thereto, and various modifications may be made within the scope of the claims, the detailed description of the disclosure, and the attached drawings, which also fall within the scope of the present disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.Accordingly, it will be understood by those of skill in the art that various changes in form and details may be made without departing from the spirit and scope of the present invention as set forth in the following claims.

What is claimed is:

1. A rechargeable battery, comprising:
an electrode assembly comprising a first electrode and a second electrode;
a case housing the electrode assembly;
a cap plate coupled to an opening of the case, the cap plate having a terminal hole and a vent hole configured to discharge gas;
an electrode terminal installed in the cap plate, the electrode terminal comprising a first electrode terminal and a second electrode terminal;
a lead tab comprising a first current collecting tab connecting the electrode assembly to the first electrode terminal and a second current collecting tab connecting the electrode assembly to the second electrode terminal; and
an opening and closing unit configured to open or close in response to the pressure of the gas is in the vent hole.

2. The rechargeable battery as claimed in claim 1, wherein the opening and closing unit comprises:
a vent plate installed at an opening position on one side of the vent hole, the vent plate having an exhaust hole through which gas is emitted;
an elevation member installed at an opening position on another side of the vent hole to close the vent hole, the elevation member moving into the vent hole in response to the pressure of the gas to open the vent hole; and
an elastic member between the vent plate and the elevation member.

3. The rechargeable battery as claimed in claim 2, wherein the exhaust hole of the vent plate includes a plurality of exhaust holes.

4. The rechargeable battery as claimed in claim 3, wherein the plurality of exhaust holes are in a round-shaped array on the vent plate.

5. The rechargeable battery as claimed in claim 3, wherein the plurality of exhaust holes are in a radial arrangement centered on the through hole of the vent plate.

6. The rechargeable battery as claimed in claim 4, wherein the plurality of exhaust holes are connected to each other.

7. The rechargeable battery as claimed in claim 6, wherein the plurality of exhaust holes are connected to each other by a notch groove on a surface of the vent plate.

8. The rechargeable battery as claimed in claim 7, wherein the notch groove connects the plurality of exhaust holes in a round shape on the surface of the vent plate.

9. The rechargeable battery as claimed in claim 7, wherein the notch groove connects the plurality of exhaust holes in a polygonal shape on the surface of the vent plate.

10. The rechargeable battery as claimed in claim 7, wherein a width of the notch groove is smaller than a diameter of the exhaust hole.

11. The rechargeable battery as claimed in claim 7, wherein the notch groove is ruptured when gas is discharged at a pressure exceeding a predetermined level.

12. The rechargeable battery as claimed in claim 8, wherein:
the vent hole has a cone shape in which a first opening having a first diameter is on an upper surface of the cap plate, and
a second opening having a second diameter is on a lower surface of the cap plate.

13. The rechargeable battery as claimed in claim 12, wherein the second diameter of the second opening is smaller than the first diameter of the first opening.

14. The rechargeable battery as claimed in claim 13, wherein:
the elevation member comprises an insertion portion that protrudes, the insertion portion being in the second opening of the vent hole in a non-operating state.

15. The rechargeable battery as claimed in claim 14, wherein the elevation member comprises:
an elevation body having an inclined surface contacting an inner wall surface of the vent hole; and
the insertion portion protruding from a lower part of the elevation body to be inserted into the second opening.

16. The rechargeable battery as claimed in claim 15, wherein the insertion portion protrudes in a cylindrical shape from the lower part of the elevation member.

17. The rechargeable battery as claimed in claim 11, wherein the vent plate has a circular plate shape making surface contact with an inner wall surface of the first opening.

18. The rechargeable battery as claimed in claim 2, wherein the elastic member is a coil spring between the vent plate and the elevation member.

19. The rechargeable battery as claimed in claim 18, wherein a first groove is on an inner surface of the vent plate to receive one side of the coil spring.

20. The rechargeable battery as claimed in claim 19, wherein a second groove is on an outer surface of the elevation member to receive another side of the coil spring.
